(19) United States
(12) Patent Application Publication
(10) Pub. No.: US 2026/0229523 A1
(43) Pub. Date: Aug. 6, 2026

(54) POSITIVE ELECTRODE ADDITIVE FOR LITHIUM SECONDARY BATTERY AND POSITIVE ELECTRODE FOR LITHIUM SECONDARY BATTERY COMPRISING SAME

(71) Applicants: HYUNDAI MOTOR COMPANY, Seoul (KR); KIA CORPORATION, Seoul (KR); Industry Academic Cooperation Foundation of KyungHee University, Yongin-si (KR)

(72) Inventors: Changhoon Song, Hwaseong-si (KR); Taeho Park, Hwaseong-si (KR); Eungju Lee, Hwaseong-si (KR); Sooyoung Yang, Hwaseong-si (KR); Dowook Jun, Hwaseong-si (KR); Seung-Min Oh, Hwaseong-si (KR); Duckgun Mok, Hwaseong-si (KR); Yun Seong Byeon, Seoul (KR); Dongil Kim, Ulsan (KR); Jaewoo Jung, Yongin-si (KR); Min-Sik Park, Seoul (KR)

(73) Assignees: HYUNDAI MOTOR COMPANY, Seoul (KR); KIA CORPORATION, Seoul (KR); Industry Academic Cooperation Foundation of KyungHee University, Yongin-si (KR)

(21) Appl. No.: 19/221,982

(22) Filed: May 29, 2025

(30) Foreign Application Priority Data
Feb. 6, 2025 (KR) 10-2025-0015035

(51) Int. Cl. H01M 4/62; C01G 53/42; C01G 53/82; H01M 4/02; H01M 4/13; H01M 10/0525; H01M 10/42

(52) U.S. Cl. CPC H01M 4/62; C01G 53/42; C01G 53/82; H01M 4/13; H01M 10/0525; H01M 10/4235; C01P 2002/54; C01P 2002/72; C01P 2002/76; C01P 2002/82; C01P 2002/85; C01P 2006/40; H01M 2004/028

(57) ABSTRACT

A positive electrode additive for a lithium secondary battery and a positive electrode for a lithium secondary battery comprising same. The positive electrode additive for a lithium secondary battery according to the present disclosure may minimize the content of unreacted NiO, thereby exhibiting improved electrochemical properties, and may suppress gas generation during an initial charging process, thereby ensuring structural stability of the battery.

### CROSS-REFERENCE TO RELATED APPLICATION

This application claims the benefit of priority to Korean Patent Application No. 10-2025-0015035, filed on Feb. 6, 2025, in the Korean Intellectual Property Office, the entire disclosure of which is incorporated herein by reference.

### FIELD

The present disclosure relates to a positive electrode additive for a lithium secondary battery and a positive electrode for a lithium secondary battery comprising same.

### BACKGROUND

Secondary batteries are widely used as high-performance energy sources for various applications, from large-capacity power storage batteries for electric vehicles and battery power storage systems to small electronic devices such as mobile phones, camcorders, laptops, and the like. In particular, as the demand for miniaturization and long-duration continuous use of portable electronic devices increases, secondary batteries that can achieve both small sizes and high capacity are required, along with reducing the weight and low-power consumption of battery components.

Among secondary batteries, lithium secondary batteries are widely used due to their advantages over nickel-manganese batteries and nickel-cadmium batteries, as they can provide, for example, higher energy density, greater capacity per unit area, lower self-discharge rate, and longer lifespan. Additionally, lithium secondary batteries have no memory effect and possess long-life characteristics, enhancing user convenience.

A lithium secondary battery typically includes a positive electrode, a negative electrode, an electrolyte, and a separator. Maintaining stable interfacial reactions between these components is crucial for ensuring the long lifespan and reliability of the battery. Among these components, the positive electrode is manufactured by mixing a positive electrode active material, a conductive material, and a binder, while the negative electrode is manufactured by mixing a negative electrode active material, a conductive material, and a binder. Various functional additives may be added into the electrodes to enhance performance.

Graphite-based materials have long been used as negative electrode active materials in lithium secondary batteries. However, their theoretical capacity is relatively low, thus limiting their use in next-generation batteries requiring high energy density. To overcome this limitation, research is being actively conducted on using silicon oxide (SiOx) or transition metal oxides as negative electrode active materials. These negative electrode materials, however, typically exhibit high irreversible characteristics during initial charging, resulting in initial charge loss.

To address this, positive electrode additives have been developed that are capable of compensating for the initial irreversible capacity loss of the negative electrode and improving the energy density of the battery. Representative positive electrode additives include Li₂NiO₂— or Li₂CuO₂-based additives comprising excess lithium. These additives contribute to compensating for the initial irreversible capacity loss of the negative electrode by reducing unreacted NiO content and inducing additional oxidation-reduction reactions through excess lithium. However, these positive electrode additives react with atmospheric moisture or carbon dioxide, generating byproducts such as Li₂CO₃ and/or LiOH. These byproducts cause side reactions with the electrolyte, leading to gas generation and degradation of electrochemical performance.

To address this, a technique has been developed in which Li₂NiO₂-based positive electrode additives are prepared through Fe transition metal substitution, thereby suppressing gas generation. While Fe substitution can effectively suppress gas generation even under repeated charge-discharge conditions, it still presents a limitation in that it leads to a decrease in initial charge capacity and, thus, additional improvements are needed.

### SUMMARY

An aspect of the present disclosure is to provide a positive electrode additive for a lithium secondary battery having a minimized content of unreacted NiO, and a positive electrode for a lithium secondary battery comprising same.

Another aspect of the present disclosure is to provide a positive electrode additive for a lithium secondary battery capable of suppressing gas generation during an initial charging process, and a positive electrode for a lithium secondary battery comprising same.

Another aspect of the present disclosure is to provide a positive electrode additive for a lithium secondary battery applicable to green technology fields utilizing batteries, such as electric vehicles, and a positive electrode for a lithium secondary battery comprising same.

The present disclosure provides a positive electrode additive for a lithium secondary battery represented by Chemical Formula 1 below.

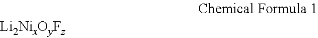

In Chemical Formula 1, x may be in the range of 0.95<x<1.00, y may be in the range of 1.90<y<2.00, and z may be in the range of 0.00<z<0.10.

The positive electrode additives falling within the scope of the disclosure can exhibit various advantages and properties and can be characterized, in accordance with some aspects and embodiments, using various techniques. According to one non-limiting example embodiment of the present disclosure, the positive electrode additive may exhibit a peak at a binding energy of 57±0.5 eV and a peak at a binding energy of 686±0.5 eV in X-ray photoelectron spectroscopy (XPS) analysis.

According to one non-limiting example embodiment of the present disclosure, the positive electrode additive may have an orthorhombic crystal structure.

According to one non-limiting example embodiment of the present disclosure, the positive electrode additive may exhibit an Ag mode peak at 365±5 cm⁻¹ and a Bg2 mode peak at 615±5 cm⁻¹ in Raman analysis.

According to one non-limiting example embodiment of the present disclosure comprising Raman analysis, the positive electrode additive may have an intensity ratio (I₁/I₂) of an Ag mode peak intensity (I₁) to a Bg2 mode peak intensity (I₂) in the range of 0.99 to 1.01.

According to another aspect of the present disclosure, a positive electrode for a lithium secondary battery comprising the positive electrode additive in accordance with the aspects and embodiments described herein, and a positive electrode material is provided.

In embodiments of this aspect, the positive electrode may comprise the positive electrode additive in accordance with the aspects and embodiments described herein, and the positive electrode material in a weight ratio ranging from 1:5 to 1:20 (positive electrode additive:positive electrode material).

According to one non-limiting example embodiment of the present disclosure, the positive electrode may further comprise a conductive material and a binder.

According to another aspect of the present disclosure, a lithium secondary battery comprising the positive electrode or the positive electrode additive, in accordance with the aspects and embodiments described herein is provided.

The positive electrode additive for a lithium secondary battery according to some embodiments of the present disclosure may minimize the content of unreacted NiO, which can thereby provide one or more improved electrochemical properties.

The positive electrode additive for a lithium secondary battery according to some non-limiting embodiments of the present disclosure may suppress gas generation during the initial charging process, thereby providing structural stability of the battery.

In another aspect, the disclosure provides a method for making a positive electrode additive for a lithium secondary battery comprising:
mixing an amount of a lithium oxide, an amount of a nickel oxide, and an amount of a nickel fluoride to form an additive mixture;
applying pressure to the additive mixture in a pelletizer under conditions sufficient to form additive mixture pellets; and
heat-treating the additive mixture pellets in a furnace by increasing the temperature at a heating rate of 2° C./min to 10° C./min to a temperature of 500° C. to 1000° C., and heating for a total time ranging from 5-30 hours to form the positive electrode additive;
   wherein the amount of lithium oxide, the amount of nickel oxide, and the amount of nickel fluoride are added to the additive mixture in a molar ratio to provide a positive electrode additive of Formula 1:

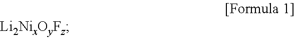

and wherein x is in the range of 0.95<x<1.00, y is in the range of 1.90<y<2.00, z is in the range of 0.00<z<0.10.

Other aspects and embodiments falling within the scope of the disclosure will be apparent to those of skill in the art in light of the following detailed description, drawings, and the appended claims.

### BRIEF DESCRIPTION OF THE DRAWINGS

The foregoing and other aspects, features, and advantages, as well as the following detailed description of the embodiments, will be better understood when read in conjunction with the accompanying drawings and illustrative examples. However, the present disclosure is not intended to be limited to the details shown in the drawings or provided in the examples, and various modifications and structural changes may be made therein without departing from the spirit of the present disclosure and within the scope and range of equivalents of the claims. Like reference numbers and designations in the various drawings indicate like elements.

FIG. 1 is a flow chart of a method for manufacturing a positive electrode additive for a lithium secondary battery according to one embodiment of the present disclosure.

FIG. 2 shows X-ray diffraction (XRD) analysis results for the illustrative comparative examples and examples.

FIG. 3 shows Raman analysis results for the illustrative comparative examples and examples.

FIG. 4A, FIG. 4B, and FIG. 4C show X-ray photoelectron spectroscopy (XPS) analysis results for the illustrative comparative examples and examples.

FIG. 5 shows electrochemical performance evaluation results of coin cells comprising the positive electrode additive of the illustrative comparative examples and examples.

FIG. 6 shows impedance analysis results of coin cells comprising the positive electrode additive of the illustrative comparative examples and examples.

FIG. 7 shows PAT-cell gas electrochemical performance evaluation and gas generation measurement results for coin cells comprising the positive electrode additive of the illustrative comparative examples and examples.

FIG. 8 shows electrochemical performance evaluation results of full cells comprising the positive electrode additive of the illustrative comparative examples and examples.

FIG. 9 shows lifespan characteristic evaluation results of full cells comprising the positive electrode additive of the illustrative comparative examples and examples.

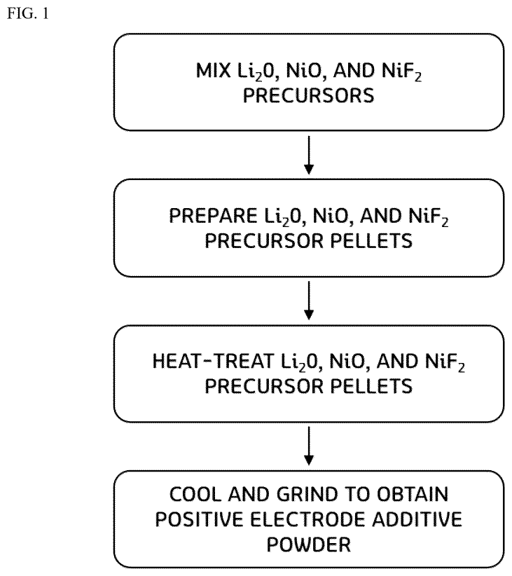

### DETAILED DESCRIPTION

Hereinafter, the present disclosure will be described in more detail. However, the following embodiments and implementation examples are provided merely as references for describing the present disclosure in detail, and the present disclosure is not limited thereto and may be implemented in various forms

Unless otherwise defined, all technical and scientific terms used herein have the same meaning as commonly understood by those skilled in the art to which the present disclosure pertains.

The terms used herein are intended merely to describe particular embodiments effectively and are not intended to limit the present disclosure.

Singular forms “a,” “an,” and “the” used in the specification and the appended claims are intended to include plural referents unless the context clearly dictates otherwise.

The units used in this specification, unless otherwise stated, are based on weight. For instance, the units such as “%” or “ratio” refer to weight percent (wt. %) or weight ratio, respectively. Unless otherwise defined, weight percent (wt. %) refers to the proportion of a specific component within the total composition, expressed as a percentage by weight.

In the present disclosure, it should be understood that term “comprising” or “having” or “including” (and similar inclusive terms) indicates that a feature, a number, a step, an operation, a component, a part or a combination thereof described in the specification is present, but does not exclude a possibility of presence or addition of one or more other features, numbers, steps, operations, components, parts or combinations thereof, in advance. It will be appreciated that those terms are also inclusive of the term “consisting of” or “consisting essentially of” which particular terms, when used throughout the disclosure or claims, generally indicate that a feature, a number, a step, an operation, a component, a part or a combination thereof described in the specification is present, and does not include any additional feature(s).

In addition, numerical ranges used in this specification may include all values between the lower and upper limits, all values incrementally derived logically within shape and breadth of the defined ranges, all double-limited values, and all possible combinations of upper and lower limits of differently limited numerical ranges. Unless specifically defined in the specification of the present disclosure, values outside the defined numerical ranges that may occur due to experimental error or rounding off of values are also included within the defined numerical ranges.

The following provides a more detailed description of the various aspects and embodiments that are encompassed by the present disclosure.

In an aspect, the present disclosure provides a positive electrode additive for a lithium secondary battery, represented by Chemical Formula 1 below.

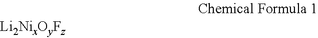

In various embodiments relating to Chemical Formula 1, x may be in the range of 0.95<x<1.00, and more specifically, 0.965≤x≤0.985, and even more specifically, 0.975≤x≤0.985; y may be in the range of 1.90<y<2.00, and more specifically, 1.93<y≤1.97, and even more specifically, 1.95≤y≤1.97; z may be in the range of 0.00<z<0.10, and more specifically, 0.03≤z≤0.07, and even more specifically, 0.03≤z≤0.05. In embodiments wherein this range is satisfied, the electrochemical properties and stability of the battery, including initial charge capacity, may be improved.

According to some example embodiments of the present disclosure, the positive electrode additive may exhibit a peak at a binding energy of 57±0.5 eV and a peak at a binding energy of 686±0.5 eV in X-ray photoelectron spectroscopy (XPS) analysis. Without being limited by any particular speculation or detail, the peak at the binding energy of 57±0.5 eV may appear in the Li 1s region, and the peak at the binding energy of 686±0.5 eV may appear in the F 1s region.

According to some example embodiments of the present disclosure, the positive electrode additive may have an orthorhombic crystal structure.

According to some example embodiments of the present disclosure, the positive electrode additive may exhibit an Ag mode peak at 365±5 cm⁻¹ and a Bg2 mode peak at 615±5 cm⁻¹ in Raman analysis.

According to some example embodiments of the present disclosure, the positive electrode additive may have an intensity ratio (I₁/I₂) of an intensity of the Ag mode peak (I₁) to an intensity of the Bg2 mode peak (I₂) in the range of 0.99 to 1.01 in Raman analysis. Without being limited by any particular speculation or detail, as the F anion is introduced into the positive electrode additive, repulsion between anions decreases, and the intensity of the Bg2 mode peak tends to decrease. In embodiments wherein the intensity ratio of these peaks satisfies the above range, improved electrochemical characteristics for the battery can be achieved.

In some additional aspects, the present disclosure provides a positive electrode for a lithium secondary battery comprising the positive electrode additive as described herein, and a positive electrode material.

According to some example embodiments of the present disclosure, the positive electrode may include the positive electrode additive and the positive electrode material in a weight ratio ranging from 1:5 to 1:20, and in some specific embodiments, from 1:7 to 1:15; however it should be appreciated that those weight ratio ranges are not limiting to the entire scope, as variations in close approximation to those ranges can provide similar or the same advantages and objectives as the explicitly recited ratios of the present disclosure.

According to some example embodiments of the present disclosure, the positive electrode may further include a conductive material and a binder.

According to some example embodiments of the present disclosure, the positive electrode material may be any material commonly used for the positive electrode of a lithium secondary battery. For example, the positive electrode material may include lithium metal oxide particles comprising one or more metals such as, for example, Ni, Co, Mn, Na, Mg, Ca, Ti, V, Cr, Cu, Zn, Ge, Sr, Ag, Ba, Zr, Nb, Mo, Al, Ga, and/or B, and combinations thereof.

The conductive material and binder are also not limited to the above and may be used without limitation as long as they are known or familiar to one of skill in the art.

In another aspect, the present disclosure provides a lithium secondary battery comprising the positive electrode in accordance with the aspects and embodiments described herein. In yet another additional aspect, the present disclosure provides a lithium secondary battery comprising the positive electrode additive in accordance with the aspects and embodiments described herein.

According to some example embodiments of the present disclosure, the lithium secondary battery may further include an electrolyte, a negative electrode, and a separator.

The electrolyte, negative electrode, and separator materials suitable for use in the aspects and embodiments of the disclosure are not particularly limited and may be selected from materials known in the art. Some further detailed and non-limiting examples are described below.

In some example embodiments of the present disclosure, the negative electrode may be manufactured by preparing a mixture by mixing and stirring a negative electrode active material with a solvent, and if necessary, a binder, a conductive material, and a dispersant, and then coating the mixture onto a metal current collector, drying the mixture, and pressing (i.e., applying pressure to) the mixture.

The negative electrode active material in some example embodiments may be any active material commonly used in the negative electrode of a lithium secondary battery. Some non-limiting examples of the negative electrode active material of a lithium secondary battery may preferably comprise a material capable of lithium intercalation. In some example embodiments of the present disclosure, the negative electrode active material may include one or more materials such as, for example, lithium (metal lithium), graphitizable carbon, non-graphitizable carbon, graphite, silicon, Sn alloy, Si alloy, Sn oxide, Si oxide, Ti oxide, Ni oxide, Fe oxide (FeO), and lithium-titanium oxides (e.g., LiTiO₂, Li₄Ti₅O₁₂ and the like).

In some example embodiments of the present disclosure, a common conductive carbon material can be used as the conductive material, without being limited to any particular conductive carbon material.

In some example embodiments of the present disclosure, the metal current collector may be any metal with high conductivity that allows the mixture of the positive or negative electrode active material to adhere easily, and is non-reactive within the voltage range of the battery. Some non-limiting example embodiments of the negative electrode current collector comprise, foils made of copper, gold, nickel, copper alloy, or combinations thereof.

In some example embodiments of the present disclosure, the separator may be a separator having micropores through which ions can pass. In some non-limiting examples, the separator may comprise a combination of one or two or more materials comprising glass fiber, polyester, polyethylene, polypropylene, and polytetrafluoroethylene, and in yet further embodiments, may be in the form of a non-woven fabric or woven fabric. In some specific embodiments, the lithium secondary battery may primarily incorporate polyolefin-based polymer separators known in the art such as, for example, polyethylene and polypropylene, but the present disclosure is not limited thereto. In some additional embodiments that may provide enhanced heat resistance and/or mechanical strength, a separator coated with a composition comprising ceramic components or polymer materials may also be used, and the separator may optionally have a single-layer or multi-layer structure. In accordance with such embodiments of the disclosure, the separator may be selected from separators known in the art, but are not limited thereto.

In accordance with the aspects and embodiments of the present disclosure, the external shape of the lithium secondary battery is not particularly limited, but may be selected from, for example, a cylindrical shape using a can, a square shape, a pouch shape, or a coin shape.

In an additional aspect, the present disclosure provides a method for preparing a positive electrode additive, comprising mixing Li₂O, NiO, and NiF₂ precursors and pelletizing the resulting mixture to form and obtain pellets, and heat-treating the pellets.

In embodiments, obtaining the pellets can comprise dry-mixing the Li₂O, NiO, and NiF₂ precursors and then pelletizing them using methods and equipment generally known in the art.

In some embodiments, the heat-treating may be performed by increasing the temperature at a heating rate of 2° C. to 10° C./min, or in some specific embodiments at a rate of 4° C. to 6° C./min, to a temperature of 500° C. to 1000° C., or in some specific embodiments to a temperature of 650° C. to 750° C., and maintaining this temperature for 5 to 30 hours, or in some specific embodiments for 10 to 20 hours.

Hereinafter, non-limiting examples and comparative examples according to the present disclosure will be described merely in an effort to provide additional illustration, context, and clarity to those of skill in the art. The following examples are merely examples falling within the scope of the present disclosure and should not be considered as limiting.

### Example 1

Li₂O (1.0 mol), NiO (0.90 mol), and NiF₂ (0.015 mol) were mixed, and subjected to a pressure of 4 tons for 5 minutes using a pelletizer to obtain pellets. Thereafter, the temperature was increased to 710° C. at a rate of 5° C. per minute in a firing furnace and maintained at the increased temperature for 17 hours. The fired product was cooled and ground, and a powder-form positive electrode additive satisfying the chemical formula Li₂Ni_{0.985}O_{1.97}F_{0.03} was obtained.

### Example 2

A powder-form positive electrode additive satisfying the chemical formula Li₂Ni_{0.975}O_{1.95}F_{0.05} was obtained using the same process as in Example 1, except that Li₂O (1.0 mol), NiO (0.95 mol), and NiF₂ (0.025 mol) were mixed prior to pellet formation.

### Example 3

A powder-form positive electrode additive satisfying the chemical formula Li₂Ni_{0.965}O_{1.93}F_{0.07} was obtained using the same process as in Example 1, except that Li₂O (1.0 mol), NiO (0.93 mol), and NiF₂ (0.035 mol) were mixed prior to pellet formation.

### Comparative Example 1

Li₂O (1.0 mol) and NiO (1.0 mol) were mixed, and subjected to a pressure of 4 tons for 5 minutes using a pelletizer to obtain pellets. Thereafter, the temperature was increased to 710° C. at a rate of 5° C. per minute in a firing furnace and maintained at the increased temperature for 17 hours. The fired product was cooled and ground, and a powder-form positive electrode additive satisfying the chemical formula Li₂NiO₂ was obtained.

### Comparative Example 2

A powder-form positive electrode additive satisfying the chemical formula Li₂Ni_{0.95}O_{1.9}F_{0.1} was obtained using the same process as in Example 1, except that Li₂O (1.0 mol), NiO (0.90 mol), and NiF₂ (0.050 mol) were mixed prior to pellet formation.

### Comparative Example 3

A conventional layered positive electrode material comprising 80 wt % or more of nickel was prepared as the positive electrode active material, without mixing a positive electrode additive.

### Analysis of Positive Electrode Additive

### 1. X-ray Diffraction Analysis

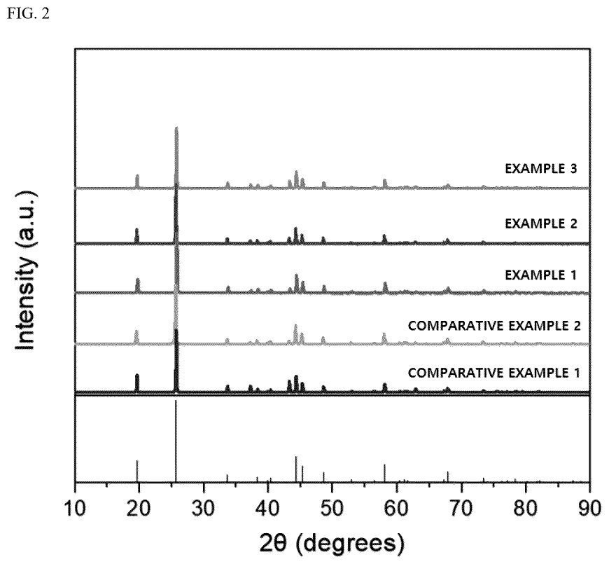

To confirm the crystal structure of the positive electrode additives in the examples and comparative examples of the present disclosure, X-ray diffraction analysis was performed, and the results are shown in FIG. 2.

As can be seen in FIG. 2, it was confirmed that Comparative Example 1 exhibited the existing crystal structure of Li₂NiO₂ (orthorhombic, Immm), and Comparative Example 2 and Examples 1, 2, and 3 exhibited the same X-ray diffraction patterns as Comparative Example 1.

### 2. Raman Analysis

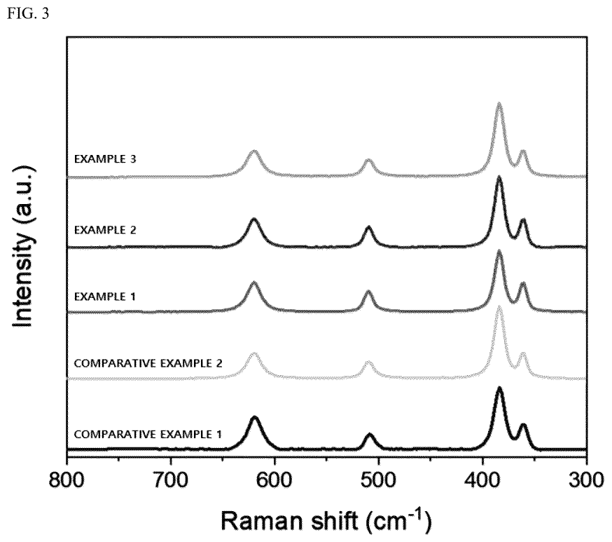

To confirm the structural characteristics of the positive electrode additives in the examples and comparative examples of the present disclosure, Raman analysis was performed, and the intensity ratio of the intensity of the Ag mode peak to the intensity of the Bg2 mode peak was calculated. The results are shown in FIG. 3 and Table 1.

TABLE 1

| | Chemical formula | I₁/I₂ |
|---|---|---|
| Comparative Example 1 | Li₂NiO₂ | 0.74 |
| Comparative Example 2 | Li₂N_{10.95}O_{1.9}F_{0.1} | 0.98 |
| Example 1 | Li₂N_{10.985}O_{1.97}F_{0.03} | 0.99 |
| Example 2 | Li₂N_{10.975}O_{1.95}F_{0.05} | 1.01 |
| Example 3 | Li₂N_{10.965}O_{1.95}F_{0.07} | 1.00 |

As can be seen in FIG. 3, both the examples and comparative examples exhibited peaks in the same regions. However, as can be seen in Table 1, compared to Comparative Example 1, in Comparative Example 2 and Examples 1 to 3 the Bg2 peak mode at 615±5 cm⁻¹ decreased, likely due to a decrease in repulsion between anions as the F anion was introduced, and thus I₁/I₂ is increased. However, the I₁/I₂ ratio did not increase proportionally with the increase in the fraction of F anions.

### 3. XPS Analysis

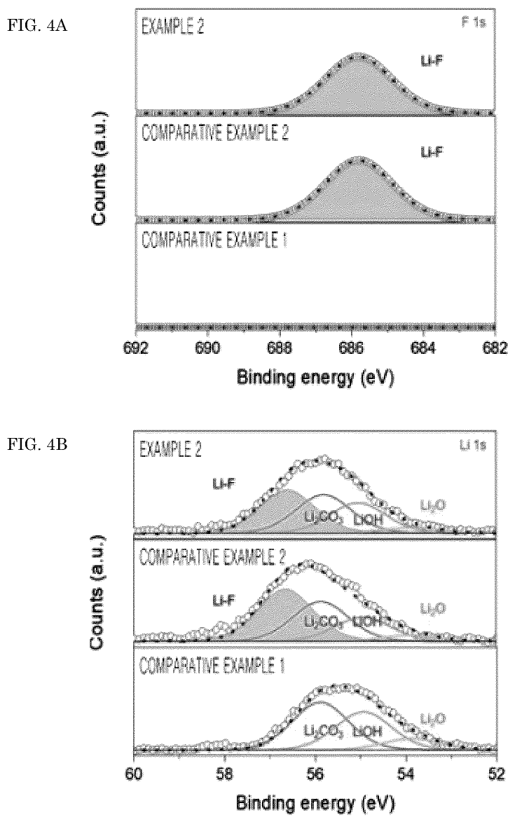

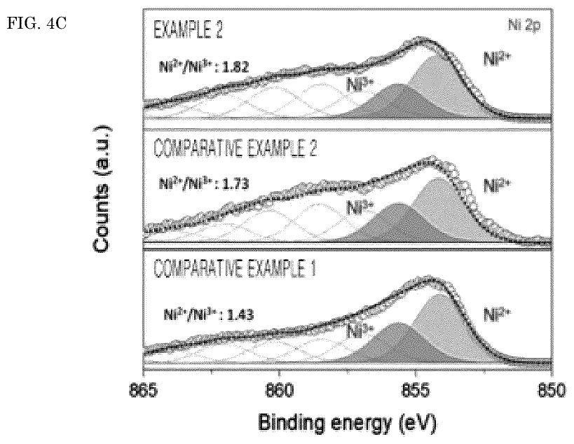

To confirm the chemical composition of the surface of the positive electrode additive in the examples and comparative examples of the present disclosure, XPS analysis was performed, and the results are shown in FIG. 4A-C.

As can be seen in FIG. 4A, unlike in Comparative Example 1, the Li—F bond (686.0 eV) was confirmed in Comparative Example 2 and Example 2.

As can be seen in FIG. 4B, unlike in Comparative Example 1, the Li—F bond (56.8 eV) was also confirmed in Comparative Example 2 and Example 2, and unlike Comparative Example 1, the intensity of residual lithium (Li₂CO₃, LiOH) and unreacted lithium (Li₂O) was reduced.

As can be seen in FIG. 4C, compared to Comparative Example 1, the introduction of F anions into the crystal structure in Comparative Example 2 and Example 2 resulted in an increase in the Ni²⁺ fraction from 58.9% to 63.5% and 64.6%, respectively.

### Electrochemical Characteristics Evaluation

To evaluate the electrochemical characteristics of batteries including the positive electrode additive of Comparative Examples 1 and 2 and Examples 1 to 3, coin cells were prepared.

In brief detail, a mixture of 10 wt % of the positive electrode additive of Comparative Examples 1 and 2 and Examples 1 to 3 and 90 wt % of a conventional layered positive electrode material was used as the positive electrode active material, and a positive electrode slurry was prepared by mixing this with a carbon black conductive material, a carbon-based additive, and polyvinylidene fluoride (PVdF) in an N-methyl-2-pyrrolidone (NMP) solvent at a weight ratio of 93:3:1:3, respectively. Thereafter, the positive electrode slurry was coated onto an aluminum foil to a thickness of 50 μm, dried, and roll pressed, and then vacuum-dried at 120° C. for 12 hours to prepare the positive electrode. For the electrolyte, a solution of 1 mol of LiPF₆ dissolved in a solvent mixture of ethylene carbonate (EC) and ethyl methyl carbonate (EMC) at a volume ratio of 1:2 was used, and conventional coin cells were prepared.

### 1. Initial Charge Capacity Evaluation

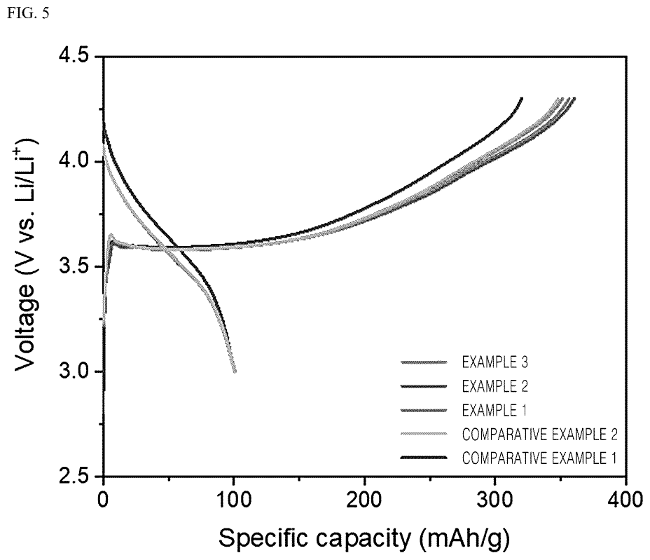

To evaluate the initial charge capacity of an electrode comprising the positive electrode additives in Comparative Examples 1 and 2 and Examples 1 to 3, the charge and discharge voltage range of the prepared coin cells was 2.5 to 4.3 V, and a charge/discharge experiment was conducted at 0.2 C/0.2 C (1.0 C=320 mAh/g), and the results are shown in FIG. 5 and Table 2.

TABLE 2

| | Charge | Discharge |
|---|---|---|
| | (mAh/g) | (mAh/g) |
| Comparative Example 1 | 320.2 | 100.0 |
| Comparative Example 2 | 347.9 | 100.2 |
| Example 1 | 356.5 | 100.8 |
| Example 2 | 360.4 | 100.2 |
| Example 3 | 351.1 | 100.1 |

As can be seen from the FIG. 5 and Table 2, the initial charge capacity increased in Examples 1 to 3 and Comparative Example 2, in which Fanions were introduced, compared to Comparative Example 1, in which no F anions were introduced.

### 2. Impedance Evaluation

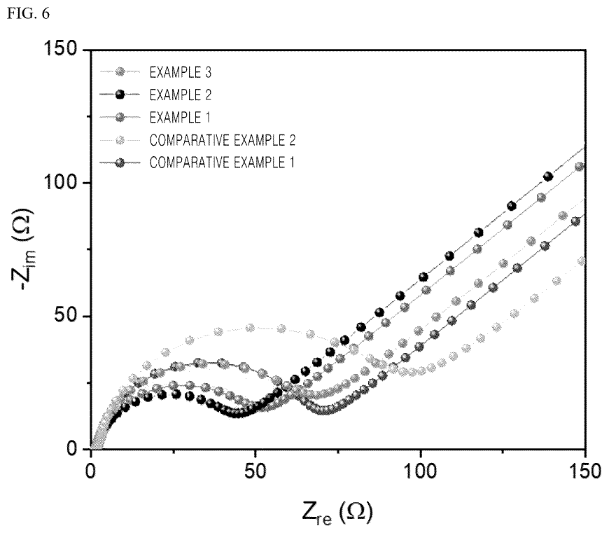

To evaluate the interfacial resistance of coin cells comprising the positive electrode additives of Comparative Examples 1 and 2 and Examples 1 to 3, electrochemical impedance spectroscopy (EIS) was performed, and the results are shown in FIG. 6 and Table 3.

TABLE 3

| | Rs (Ω) | Rct (Ω) |
|---|---|---|
| Comparative Example 1 | 1.7 | 78.5 |
| Comparative Example 2 | 1.8 | 108.2 |
| Example 1 | 1.4 | 53.7 |
| Example 2 | 1.6 | 42.8 |
| Example 3 | 1.7 | 74.6 |

As can be seen in FIG. 6 and Table 3, the interfacial resistance (Rct) decreased in Comparative Example 2 and Examples 1 to 3 compared to Comparative Example 1 due to a decrease in the residual lithium and unreacted lithium content according to the introduction of F anions.

### 3. Determining Whether Irreversible Oxidation Reactions Occur

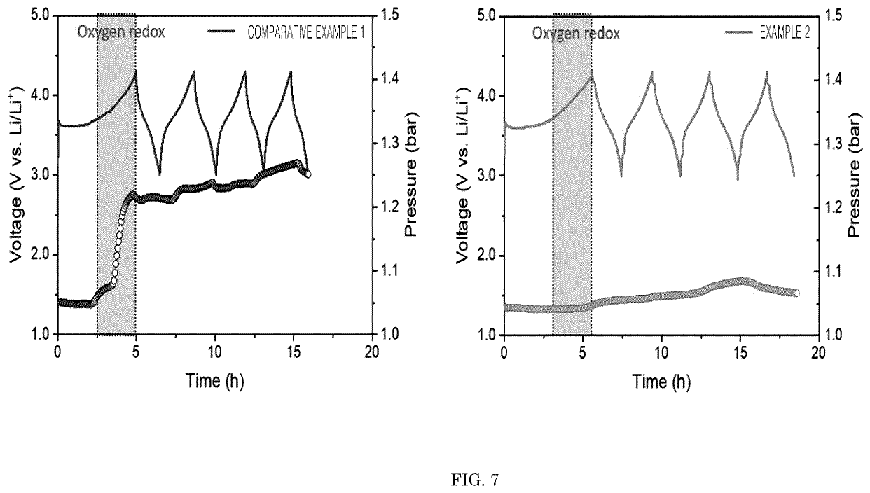

To determine whether irreversible oxidation reactions occur during the initial charging process in coin cells comprising the positive electrode additives from Comparative Example 1 and Example 2, real-time PAT-cell gas electrochemical characteristics evaluation and gas generation measurement were performed, and the results are shown in FIG. 7.

As can be seen in FIG. 7, compared to Comparative Example 1, Example 2 exhibited a significant reduction in gas generation by introducing F anions to suppress the irreversible oxidation reaction of O anions.

### 4. Full Cell Electrochemical Characteristics Evaluation

Full cells comprising the positive electrode additives from Comparative Examples 1 and 2 and Example 2 were prepared, and their electrochemical characteristics were evaluated.

In brief detail, a slurry was prepared using 10 wt % of the positive electrode additive from Comparative Examples 1 and 2 and Example 2, mixed with 90 wt % of a conventional layered positive electrode material, along with a carbon black conductive material, a carbon-based additive, and polyvinylidene fluoride (PVdF) at a weight ratio of 96:1.5:0.5:2, using N-methyl-2-pyrrolidone (NMP) as a solvent. Thereafter, the positive electrode slurry was coated onto an aluminum foil to a thickness of 50 μm, dried, and roll pressed, and then vacuum-dried at 120° C. for 12 hours to prepare the positive electrode. For the negative electrode active material, a slurry was prepared by mixing 20 wt % silicon negative electrode material and 80 wt % graphite negative electrode material with styrene-butadiene rubber (SBR) and carboxymethyl cellulose (CMC) at a weight ratio of 96:2:2, using deionized water (DI water) as a solvent. Thereafter, the negative electrode slurry was coated onto a copper foil to a thickness of 33.3 μm, dried, and roll pressed, and then vacuum-dried at 120° C. for 12 hours to prepare the negative electrode.

The N/P ratio of the full cell was designed to be 1.1. For the electrolyte, a solution of 1 mol of LiPF₆ dissolved in a solvent mixture of ethylene carbonate (EC) and ethyl methyl carbonate (EMC) at a volume ratio of 3:7 was used, and full cells were prepared.

The charge-discharge voltage range was 3.0-4.2 V, and three charge-discharge cycles were performed at 0.1 C/0.1 C, followed by 300 charge-discharge cycles at 0.5 C/0.5 C. (1.0 C=200 mA/g).

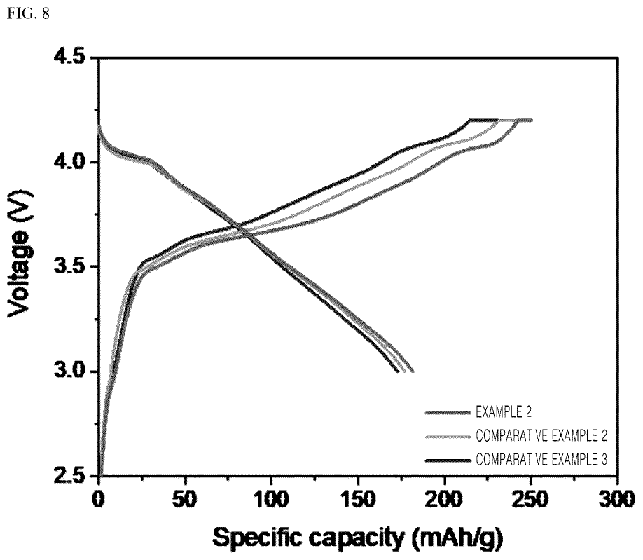

The results of the initial reversible capacity evaluation of the full cells are shown in FIG. 8 and Table 4.

TABLE 4

| | Charge | Discharge |
|---|---|---|
| | (mAh/g) | (mAh/g) |
| Comparative Example 3 | 233.8 | 172.9 |
| Comparative Example 2 | 246.1 | 177.0 |
| Example 2 | 250.4 | 181.9 |

As can be seen in FIG. 8 and Table 4, an initial reversible capacity increase of approximately 102.4% in Comparative Example 2 and 105.2% in Example 2 compared to Comparative Example 3 was confirmed.

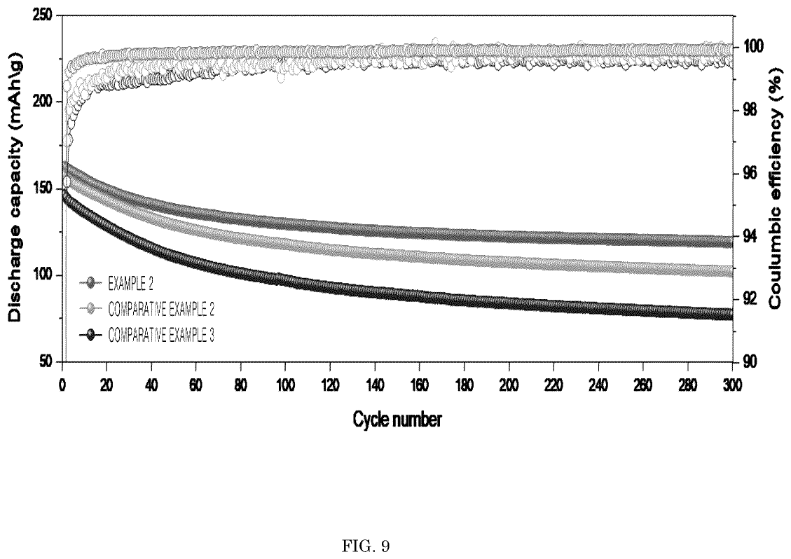

The results of evaluating the lifespan characteristics of the full cell are shown in FIG. 9.

As can be seen in FIG. 9, after 300 charge-discharge cycles, the capacity retention rate was 52.8% for Comparative Example 3, whereas it increased to 64.9% for Comparative Example 2 and 73.4% for Example 2.

These experimental results confirm that batteries comprising the positive electrode additive of the present disclosure exhibit improved electrochemical characteristics, likely due to the reduced content of unreacted NiO. Additionally, gas generation during initial charging was suppressed, thus resolving the issue of battery instability caused by cell expansion. Accordingly, it can be seen that the positive electrode additive of the present disclosure is capable of effectively suppressing the initial charge loss of negative electrodes comprising silicon oxide or transition metal oxide materials, which occurs due to high irreversible characteristics during initial charging.

The features, structures, effects, and the like described in the exemplary embodiments above fall within at least one embodiment of the present disclosure; however they are not necessarily limiting to other embodiments falling within the scope of the disclosure. Furthermore, the features, structures, effects, and the like exemplified in each exemplary embodiment can be combined or modified in other embodiments by those skilled in the art to which the embodiments pertain. Therefore, such combinations and modifications should be construed as being within the scope of the present disclosure.

What is claimed is:

1. A positive electrode additive for a lithium secondary battery comprising Formula 1: 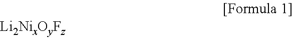
wherein x is in the range of 0.95<x<1.00, y is in the range of 1.90<y<2.00, and z is in the range of 0.00<z<0.10.

2. The positive electrode additive according to claim 1, wherein the positive electrode additive exhibits a peak at a binding energy of 57±0.5 eV and a peak at a binding energy of 686=0.5 eV in X-ray photoelectron spectroscopy (XPS) analysis.

3. The positive electrode additive according to claim 1, wherein the positive electrode additive has an orthorhombic crystal structure.

4. The positive electrode additive according to claim 1, wherein the positive electrode additive exhibits an Ag mode peak at 365±5 cm⁻¹ and a Bg2 mode peak at 615±5 cm⁻¹ in Raman analysis.

5. The positive electrode additive according to claim 4, wherein, in the Raman analysis, an intensity ratio (I₁/I₂) of an intensity of the Ag mode peak (I₁) to an intensity of the Bg2 mode peak (I₂) is in the range of 0.99 to 1.01.

6. A positive electrode for a lithium secondary battery, comprising:
the positive electrode additive according to claim 1; and
a positive electrode material.

7. The positive electrode according to claim 6, wherein the positive electrode comprises the positive electrode additive and the positive electrode material in a weight ratio that ranges from 1:5 to 1:20 (additive:material).

8. The positive electrode according to claim 6, further comprising:
a conductive material; and
a binder.

9. A lithium secondary battery comprising the positive electrode according to claim 6.

10. A lithium secondary battery comprising the positive electrode additive according to claim 1.

11. The positive electrode additive according to claim 1, wherein x has a value of 0.965≤x≤0.985.

12. The positive electrode additive according to claim 1, wherein x has a value of 0.975≤x≤0.985.

13. The positive electrode additive according to claim 1, wherein y has a value of 1.93≤y≤1.97.

14. The positive electrode additive according to claim 1, wherein y has a value of 1.95≤y≤1.97.

15. The positive electrode additive according to claim 1, wherein z has a value of 0.03≤z≤0.07.

16. The positive electrode additive according to claim 1, wherein z has a value of 0.03≤z≤0.05.

17. A method for making a positive electrode additive for a lithium secondary battery comprising:
mixing an amount of a lithium oxide, an amount of a nickel oxide, and an amount of a nickel fluoride to form an additive mixture;
applying pressure to the additive mixture in a pelletizer under conditions sufficient to form additive mixture pellets; and
heat-treating the additive mixture pellets in a furnace by increasing the temperature at a heating rate of 2° C./min to 10° C./min to a temperature of 500° C. to 1000° C., and heating for a total time ranging from 5-30 hours to form the positive electrode additive;
wherein the amount of lithium oxide, the amount of nickel oxide, and the amount of nickel fluoride are added to the additive mixture in a molar ratio to provide a positive electrode additive of Formula 1: 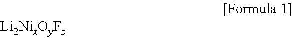
wherein x is in the range of 0.95<x<1.00, y is in the range of 1.90<y<2.00, z is in the range of 0.00<z<0.10.
